(19) United States
(12) Patent Application Publication
(10) Pub. No.: US 2021/0079998 A1
(43) Pub. Date: Mar. 18, 2021

(54) SHIFT DEVICE

(71) Applicant: KABUSHIKI KAISHA TOKAI-RIKA-DENKI-SEISAKUSHO, Aichi (JP)

(72) Inventors: Kenji NAKANISHI, Aichi (JP); Yutaka INAMURA, Aichi (JP)

(21) Appl. No.: 16/624,083

(22) PCT Filed: May 30, 2018
(86) PCT No.: PCT/JP2018/020848

§ 371 Date: Dec. 18, 2019

(30) Foreign Application Priority Data
Jun. 27, 2017 (JP) 2017-125214

(51) Int. Cl. F16H 59/08; B60K 20/08; F16H 61/16; B60K 35/00; F16H 61/18; F16H 61/22

(52) U.S. Cl. CPC F16H 59/08; B60K 20/08; F16H 61/16; B60K 35/00; F16H 2059/081; F16H 61/22; F16H 2312/12; B60K 2370/1537; B60K 2370/172; F16H 61/18

(57) ABSTRACT

A shift device for a vehicle having an automated parking mode is provided that includes a shift body and a display section. The shift body is movable into a variety of shift positions, i.e. D, N, R, and P. The display section displays not only the range of shift positions but can also display an automatic parking mode state (AP) when the shift body is in the park (P) state. The display section does not remain in the park P when the vehicle is driven into a parking place by the automatic parking mode, but instead displays the particular shift position (D, R, or N) the vehicle is in as it is being automatically parked.

### TECHNICAL FIELD

The present disclosure relates to a shift device in which a shift body is moved to change a shift range of a transmission.

### BACKGROUND ART

For example, in a vehicle disclosed in Japanese Patent Application Laid-Open (JP-A) No. 2001-88572, a select lever is movable between plural ranges, and a range position of a transmission is changed to a range position corresponding to the range of the select lever.

This vehicle is provided with a driving assistance system. When the driving assistance system is in operation, the range position of the transmission is changed in a state in which the select lever has been moved to a specific range.

### SUMMARY OF INVENTION

### Technical Problem

In consideration of the above circumstances, an object of the present disclosure is to provide a shift device capable of suppressing any confusion felt on the part of an occupant when looking at the shift device while a driving assistance mode of a vehicle is in operation.

### Solution to Problem

A first aspect of the present disclosure includes a shift body configured to be movable to plural shift positions in order to change a shift range of a transmission to a shift range corresponding to each shift position, and a display section configured to display a shift range of the transmission when the shift range is changed b operation of a vehicle driving assistance mode in a state in which the shift body is disposed at a specific shift position.

A second aspect of the present disclosure is the first aspect, wherein the display section is further configured to display that the driving assistance mode is in operation.

A third aspect of the present disclosure is the first aspect or the second aspect, further including an initiating section that is operated to initiate operation of the driving assistance mode.

A fourth aspect of the present disclosure is any one of the first aspect to the third aspect, wherein the shift range of the transmission is set to a vehicle stop state corresponding to the specific shift position when operation of the driving assistance mode is initiated and when operation of the driving assistance mode ends.

A fifth aspect of the present disclosure is any one of the first aspect to the fourth aspect, further including a restricting section configured to restrict movement of the shift body from the specific shift position during operation of the driving assistance mode.

A sixth aspect of the present disclosure is any one of the first aspect to the fifth aspect, wherein the display section is configured to display that operation of the driving assistance mode has ended.

A seventh aspect of the present disclosure is any one of the first aspect to the sixth aspect, wherein the shift body is rotated through a predetermined rotation angle to change the shift position of the shift body, and an external profile of the shift body is the same at each shift position of the shift body about an entirety of a circumferential rotation direction of the shift body.

An eighth aspect of the present disclosure is any one of the first aspect to the seventh aspect, wherein the display section is installed at the shift body.

A ninth aspect of the present disclosure is any one of the first aspect to the seventh aspect, wherein the display section is installed at a portion of the shift device other than the shift body.

A tenth aspect of the present disclosure is any one of the first aspect to the ninth aspect, wherein the shift body has an annular shape rotatable about an axis of the shift body, and the display section is installed at an inner side, in a radial direction, of the shift body.

In the first aspect of the present disclosure, the shift body is movable to plural shift positions in order to change the shift range of the transmission to the shift range corresponding to each shift position of the shift body. The display section is configured to display the shift range of the transmission when the shift range of the transmission is changed by operation of the vehicle driving assistance mode in a state in which the shift body is disposed at the specific shift position.

The shift device is provided with the display section, and the display section displays the shift range of the transmission by operation of the vehicle driving assistance mode. Thus, when the shift range of the transmission is changed by operation of the vehicle driving assistance mode in a state in which the shift body is disposed at the specific shift position, an occupant is able to perceive the shift range of the transmission by looking at the display section of the shift device. This enables any confusion felt on the part of the occupant to be suppressed.

In the second aspect of the present disclosure, the display section displays that the vehicle driving assistance mode is in operation. The occupant is thus able to perceive that the vehicle driving assistance mode is in operation when looking at the shift device.

In the third aspect of the present disclosure, the initiating section is operated to initiate operation of the vehicle driving assistance mode.

The initiating section is provided to the shift device. This enables the occupant to use the shift device to perceive the operation status of the vehicle driving assistance mode.

In the fourth aspect of the present disclosure, the shift range of the transmission is set to the specific shift range to adopt the vehicle stop state corresponding to the specific shift position when operation of the vehicle driving assistance mode is initiated and when operation of the vehicle driving assistance mode ends. The vehicle can accordingly be placed in the stop state at both initiation and the end of operation of the vehicle driving assistance mode.

In the fifth aspect of the present disclosure, the restricting section restricts movement of the shift body from the specific shift position during operation of the vehicle driving assistance mode. This enables movement of the shift body from the specific shift position to be restricted during operation of the vehicle driving assistance mode.

In the sixth aspect of the present disclosure, the display section displays that operation of the vehicle driving assistance mode has ended. This enables the occupant to perceive that operation of the vehicle driving assistance mode has ended by looking at the shift device.

In the seventh aspect of the present disclosure, the shift body is rotated through the predetermined rotation angle to change the shift position of the shift body. Moreover, the external profile of the shift body is the same at each shift position of the shift body about an entirety of the circumferential rotation direction of the shift body. Thus, the occupant does not have to look at the external profile of the shift body to perceive the shift position of the shift body. This enables any confusion felt on the part of the occupant when looking at the shift device to be suppressed.

In the eighth aspect of the present disclosure, the display section is installed at the shift body. The display section may be incorporated into the shift body, thereby facilitating manufacture of the shift device.

In the ninth aspect of the present disclosure, the display section is installed at a portion of the shift device other than the shift body. This facilitates installation of the display section.

In the tenth aspect of the present disclosure, the shift body has a circular annular shape rotatable about an axis of the shift body, and the display section is installed at the inner side, in the radial direction, of the shift body. This enables plural display locations of the display section to be disposed near to each other.

### BRIEF DESCRIPTION OF DRAWINGS

FIG. 1 is a plan view illustrating a shift device according to an exemplary embodiment of the present disclosure.

FIG. 2 is a perspective view illustrating relevant portions of a shift device.

FIG. 3 is a configuration diagram schematically illustrating an indicator and so on of a shift device.

FIG. 4 is a flowchart illustrating display control of a shift device in an automated parking mode.

FIG. 5A is a plan view schematically illustrating movement of a vehicle in an automated parking mode.

FIG. 5B is a plan view schematically illustrating movement of a vehicle in an automated parking mode.

FIG. 5C is a plan view schematically illustrating movement of a vehicle in an automated parking mode.

FIG. 5D is a plan view schematically illustrating movement of a vehicle in an automated parking mode.

FIG. 5E is a plan view schematically illustrating movement of a vehicle in an automated parking mode.

FIG. 5F is a plan view schematically illustrating movement of a vehicle in an automated parking mode.

FIG. 6A is a plan view illustrating a changing display on an indicator in an automated parking mode.

FIG. 6B is a plan view illustrating a changing display on an indicator in an automated parking mode.

FIG. 6C is a plan view illustrating a changing display on an indicator in an automated parking mode.

FIG. 6D is a plan view illustrating a changing display on an indicator in an automated parking mode.

FIG. 6E is a plan view illustrating a changing display on an indicator in an automated parking mode.

FIG. 6F is a plan view illustrating a changing display on an indicator in an automated parking mode.

FIG. 6G is a plan view illustrating a changing display on an indicator in an automated parking mode.

### DESCRIPTION OF EMBODIMENTS

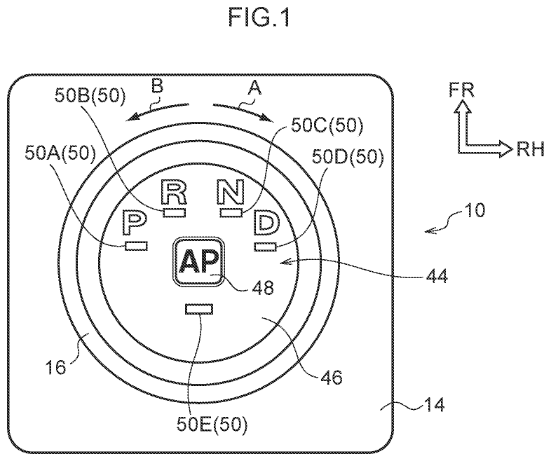

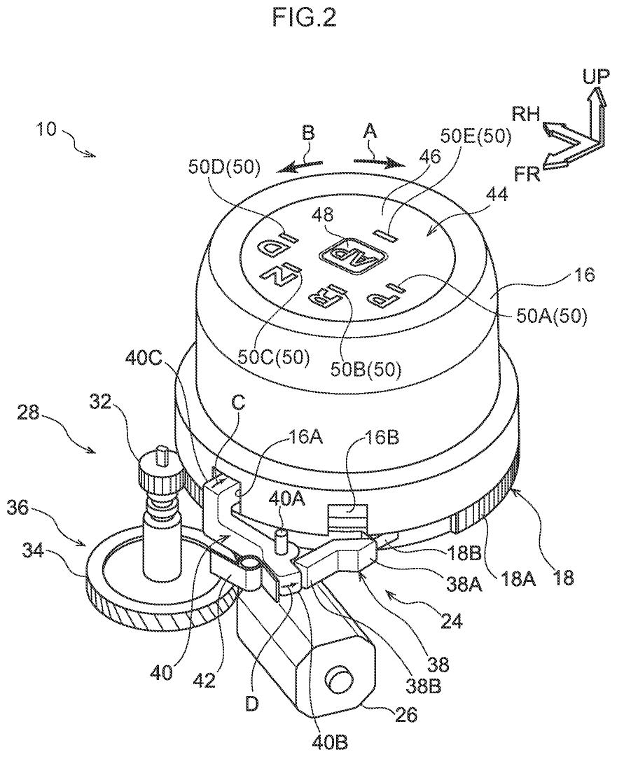

Detailed explanation follows regarding an exemplary embodiment of the present disclosure, with reference to the drawings. FIG. 1 is a plan view illustrating a shift device 10 according to an exemplary embodiment of the present disclosure. FIG. 2 is a perspective view illustrating relevant portions of the shift device 10 as viewed obliquely from the front-left side. Note that in the drawings, the arrow UP indicates the upper side of the shift device 10, the arrow FR indicates the front of the shift device 10, and the arrow RH indicates the right of the shift device 10.

The shift device 10 according to the present exemplary embodiment is what is referred to as a by-wire shift device. The shift device 10 is disposed on a vehicle (automobile) console 14 at the vehicle front side and vehicle width direction inside of a driver's seat (not illustrated in the drawings) of the vehicle. The front, right, and upper side of the shift device 10 are respectively oriented toward the front, right, and upper side of the vehicle.

As illustrated in FIG. 2, a knob 16 having a substantially circular tube shape (a circular ring shaped outer profile), serving as a shift body, is provided to the shift device 10. A lower end of the knob 16 is rotatably (movably) supported by a non-illustrated casing, and the casing is fixed to the inside of the console 14 (to the vehicle body side). An axial direction of the knob 16 runs parallel with the up-down direction. The knob 16 is rotatable in one direction (the arrow A direction in FIG. 1) and another direction (the arrow B direction in FIG. 1) over a predetermined range (a predetermined angle range). An upper portion of the knob 16 projects from the console 14 into the vehicle cabin (see FIG. 1), and the knob 16 is capable of being rotation-operated by a vehicle occupant (a driver's seated in the driver's seat).

By rotation-operating the knob 16 in the other direction (arrow B direction), the knob 16 can be disposed at a P position (parking position), serving as a shift position (specific shift position). By rotation-operating the knob 16 in the one direction (arrow A direction) from a state disposed at the P position, the knob 16 can be disposed at an R position (reverse position), an N position (neutral position), and a D position (drive position), serving as shift positions. The shift position changes each time the knob 16 is rotated by a predetermined rotation angle. A portion of the knob 16 exposed toward the vehicle cabin when this is performed is configured similarly around the entirety of a circumferential rotation direction, such that the external profile (the appearance) of the knob 16 is the same at each shift position.

As illustrated in FIG. 2, a lever engagement recess 16A is formed in part of a lower end portion of the knob 16. The lever engagement recess 16A opens toward a radial direction outside. Note that a lever engagement recess 16B is formed on the other direction side (arrow B direction side) of the part of the lower end portion of the knob 16 formed with the lever engagement recess 16A. The lever engagement recess 16B is employed to retain the knob 16 at the N shift position.

An annular shaped rotor cam 18, serving as a moving member, is disposed at the lower side of the knob 16. The rotor cam 18 is disposed coaxially to the knob 16. Outer teeth 18A are formed at an outer peripheral portion of the rotor cam 18. The outer teeth 18A are formed over a predetermined range about the circumferential direction of the rotor cam 18. An engagement protrusion 18B, serving as an engagement portion, is formed to the outer peripheral portion of the rotor cam 18 at a location where the outer teeth 18A are not formed. The engagement protrusion 18B projects toward a radial direction outside of the rotor cam 18.

A shift lock mechanism 24, serving as a restricting section and a restriction release section, is provided to the shift device 10. The shift lock mechanism 24 is configured including a motor 26 serving as a drive means, and a transmitting mechanism 28.

The transmitting mechanism 28 is configured including the rotor cam 18, a worm gear (not illustrated in the drawings) provided to a rotation shaft of the motor 26, and an intermediate gear 36 including a first intermediate gear 32 that meshes with the outer teeth 18A of the rotor cam 18 and a second intermediate gear 34 that meshes with the worm gear and rotates integrally with the first intermediate gear 32.

The shift lock mechanism 24 is configured including a first lever 38 and second lever 40, serving as restricting bodies, and a return spring 42 that biases the second lever 40.

The first lever 38 is formed in a substantially rod shape, and an end portion on one length direction side of the first lever 38 configures an engaged portion 38A. An end portion on the other length direction side of the first lever 38 configures a pressing portion 38B. The first lever 38 is slidable (capable of being displaced) toward the other length direction side and is supported by the non-illustrated casing.

The second lever 40 is formed in a substantially L shape as viewed from the upper side. A pivot shaft portion 40A formed in a circular column shape with its axial direction along the up-down direction is provided on the first lever 38 side of a length direction intermediate portion of the second lever 40. The pivot shaft portion 40A of the second lever 40 is supported by the casing, such that the second lever 40 is capable of pivoting about the pivot shaft portion 40A. An end portion on the first lever 38 side of the second lever 40 configures a pressed portion 40B. An end portion of the second lever 40 on the opposite side to the pressed portion 40B configures a restricting projection 40C. The restricting projection 40C projects toward the knob 16.

The return spring 42 is formed by bending a plate shaped sheet steel material or the like. One portion of the return spring 42 abuts the casing. Another portion of the return spring 42 abuts a face of the pressed portion 40B of the second lever 40 on the opposite side of the pressed portion 40B to the first lever 38. The second lever 40 is biased so as to pivot in the arrow D direction by the biasing force of the return spring 42.

An indicator 44, serving as a display section, is provided at the radial direction inside of the knob 16 of the shift device 10. The indicator 44 includes a circular plate shaped indicator panel 46. An outer diameter of the indicator panel 46 is smaller than an inner diameter of the knob 16. The indicator panel 46 is disposed coaxially to the knob 16. The indicator panel 46 is supported by the casing, and the knob 16 is rotatable relative to the indicator panel 46.

An automated parking (AP) switch 48, serving as an initiating section, is provided at a central portion of the indicator panel 46. The AP switch 48 is a momentary switch that only closes (or opens) a contact while it is being press-operated. Note that although the AP switch 48 is provided in the present exemplary embodiment, an automated driving (AD) switch or the like may be provided.

Plural lamps (LEDs) 50, serving as display means (display locations), are disposed on the indicator panel 46. In the present exemplary embodiment, five lamps 50A to 50E are employed. The lamp 50E is disposed near to the rear side of the AP switch 48 on the indicator panel 46 and corresponds to the AP switch 48. The lamps 50A to 50D are sequentially disposed on progression around the circumferential direction of the indicator panel 46 in the one direction, such that the lamp 50B and the lamp 50C are disposed at the front side. The respective lamps 50A, 50B, 50C, and 50D thereby correspond to the P position, the R position, the N position, and the D position in this sequence. Out of the lamps 50A to 50D, the lamp 50 that corresponds to a shift range of the transmission is illuminated on the indicator 44 so as to display the shift range of the transmission. Note that configuration may be such that the indicator 44 displays the shift position of the knob 16 when in a normal mode, and the shift range of the transmission when in an automated parking mode described below.

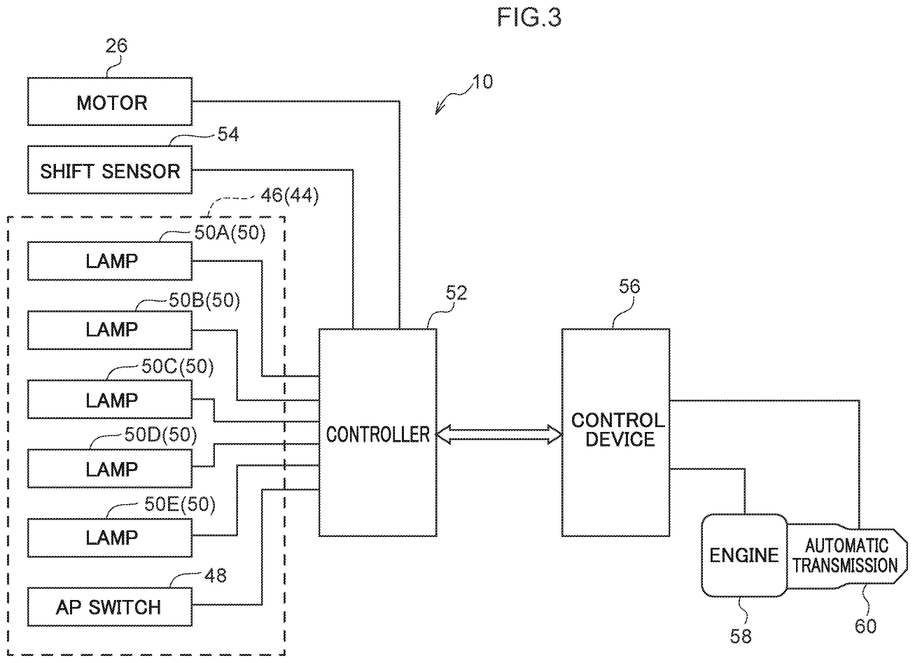

FIG. 3 is a block diagram illustrating configuration of the indicator 44 and so on. A controller 52, serving as a control section, is configured including a standard microcomputer (or an ASIC) in which a CPU, RAM, ROM, non-volatile memory (EEPROM), and so on are connected together by a bus. Each of the lamps 50A to 50E and the AP switch 48 of the indicator 44 are electrically connected to the controller 52. The controller 52 controls the passage of current to the lamps 50A to 50E to control illumination of the lamps 50A to 50E. When the AP switch 48 is operated, the controller 52 detects the operation of the AP switch 48.

A shift sensor (rotation position sensor) 54, serving as a detection means that detects the rotation position (shift position) of the knob 16, is provided to the shift device 10. The shift sensor 54 is electrically connected to the controller 52. The shift sensor 54 is attached to the knob 16 or to the casing that supports the knob 16. The shift sensor 54 outputs an electrical signal corresponding to the rotation position (movement position) of the knob 16, and the controller 52 detects the shift position of the knob 16 based on the electrical signal from the shift sensor 54.

The motor 26 is also electrically connected to the controller 52. The controller 52 controls the passage of current to the motor 26 and thereby controls operation of the shift lock mechanism 24.

A control device (travel control device) 56, configuring a driving assistance device, is provided to the vehicle. The control device 56 is operatable in the automated parking mode serving as a driving assistance mode, and is also oparatable in the normal mode.

The control device 56 is connected to the controller 52 (electrically connected to the controller 52) and is capable of communicating (exchanging data) with the controller 52. An engine 58 (or a vehicle travel motor), serving as a vehicle travel drive source, and an automatic transmission (falling under the broad definition of a transmission) 60 are connected to the control device 56. The control device 56 controls driving of the engine 58 (engine control) and controls the shift range of the automatic transmission 60 (shift control).

During operation of the normal mode, when a change in the shift position of the knob 16 is detected by the controller 52, the control device 56 changes the shift range of the automatic transmission 60 to the shift range corresponding to each shift position of the knob 16. The controller 52 also illuminates the lamp 50 (50A to 50D) corresponding to each shift range of the automatic transmission 60. Thus, when the shift position of the knob 16 is changed to the P position, R position, N position, or D position, the shift range of the automatic transmission 60 changes to the corresponding range out of a P range (parking range) serving as a specific shift range, an R range (reverse range), an N range (neutral range), and a D range (drive range), and the corresponding lamp out of the lamp 50A corresponding to the P range, the lamp 50B corresponding to the R range, the lamp 50C corresponding to the N range, and the lamp 50D corresponding to the D range is illuminated.

A brake device that controls actuation of the vehicle brakes, a steering device that manipulates steering of the vehicle, a monitoring device that monitors the vehicle surroundings using an image capture device or the like, and so on (none of which are illustrated in the drawings) are connected to the control device 56. When operating in the automated parking mode, the control device 56 performs shift control of the automatic transmission 60, steering control, vehicle speed control, and brake control, while ascertaining objects in the vehicle surroundings using the image capture device and detecting the distance to the ascertained objects.

When the AP switch 48 of the shift device 10 is operated in a state in which the shift range of the automatic transmission 60 is set to the P range, the control device 56 operates in the automated parking mode. When operating in the automated parking mode, the control device 56 identifies a space where the vehicle can park (a parking space) based on a captured image of the vehicle surroundings captured by the image capture device, and performs shift control, steering control, vehicle speed control, brake control, and so on while monitoring the vehicle surroundings in order to move (guide) the vehicle into the parking space. When the vehicle has completed parking in the parking space, or in cases in which the brakes are actuated by the driver to stop the vehicle while executing the automated parking mode, the control device 56 sets the automatic transmission 60 to the P range and ends the automated parking mode.

Explanation follows regarding operation of the present exemplary embodiment.

In the shift device 10, in cases in which the knob 16 is disposed at the P position (in cases in which the shift sensor 54 has detected that the shift position of the knob 16 is the P position) and the brakes have not been actuated, the motor 26 of the shift lock mechanism 24 is driven in reverse under the control of the controller 52, thereby rotating the rotor cam 18 in the arrow A direction through the worm gear and the intermediate gear 36.

When the rotor cam 18 is thus rotated in the arrow A direction, the engagement protrusion 18B of the rotor cam 18 engages with the engaged portion 38A of the first lever 38 and moves the first lever 38 toward the second lever 40 side, such that the pressing portion 38B of the first lever 38 presses the pressed portion 40B of the second lever 40. As a result, the second lever 40 is pivoted toward the arrow C direction side against the biasing force of the return spring 42, such that the restricting projection 40C of the second lever 40 is inserted into the lever engagement recess 16A of the knob 16. Rotation of the knob 16 is thus locked (restricted) at the P position, such that the knob 16 is locked (restricted) from rotating from the P position to the R position, the N position, and the D position. Note that the reverse drive of the motor 26 is stopped under the control of the controller 52 when a non-illustrated lock sensor has detected that the rotor cam 18 has rotated to a position where the restricting projection 40C of the second lever 40 is inserted into the lever engagement recess 16A of the knob 16.

In cases in which the knob 16 is disposed at the P position and the brakes have been actuated, the motor 26 of the shift lock mechanism 24 is driven forward under the control of the controller 52, thereby rotating the rotor cam 18 in the arrow B direction through the worm gear and the intermediate gear 36. The engagement protrusion 18B of the rotor cam 18 thus moves away from the engaged portion 38A of the first lever 38, and the second lever 40 is pivoted toward the arrow D direction side by the biasing force of the return spring 42. As a result, the restricting projection 40C of the second lever 40 moves out from inside the lever engagement recess 16A of the knob 16. The lock on rotation of the knob 16 is thereby released, enabling the knob 16 to be rotated from the P position to the R position, the N position, and the D position. Note that forward drive of the motor 26 is stopped under the control of the controller 52 when the non-illustrated lock sensor has detected that the rotor cam 18 has rotated to a position where the restricting projection 40C of the second lever 40 has moved out from inside the lever engagement recess 16A of the knob 16.

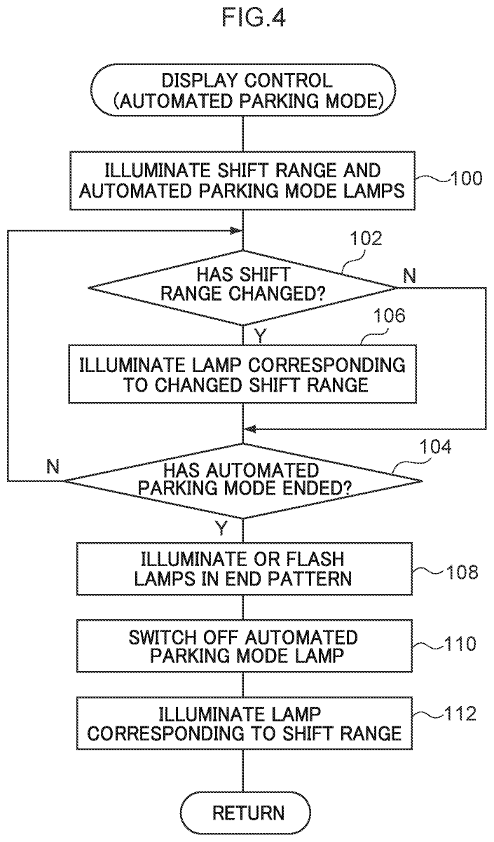

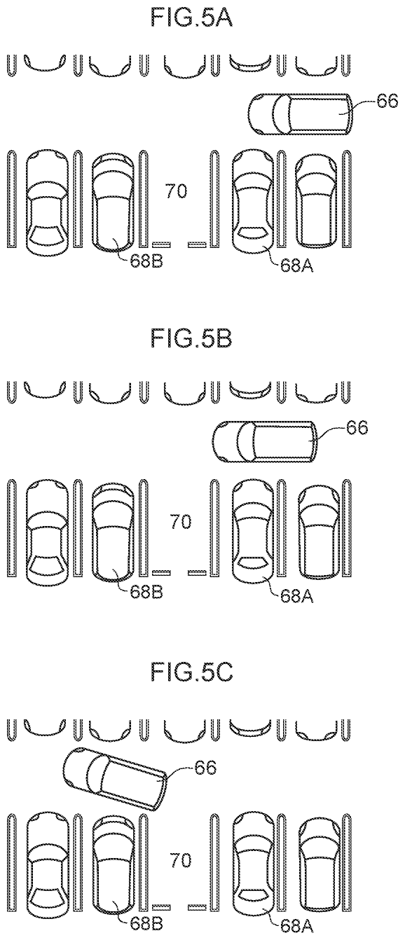

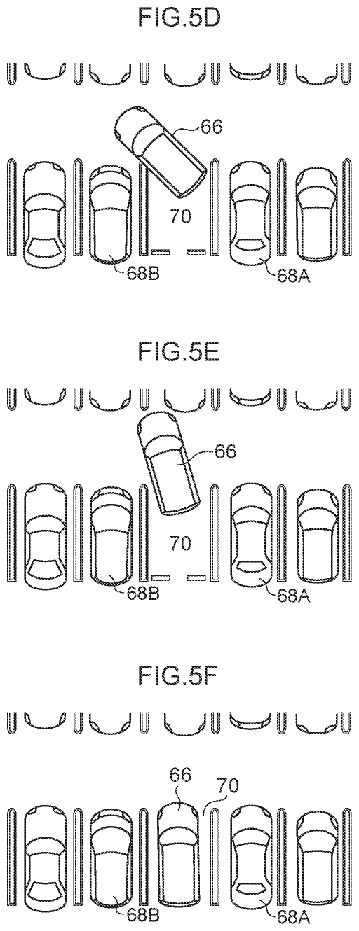

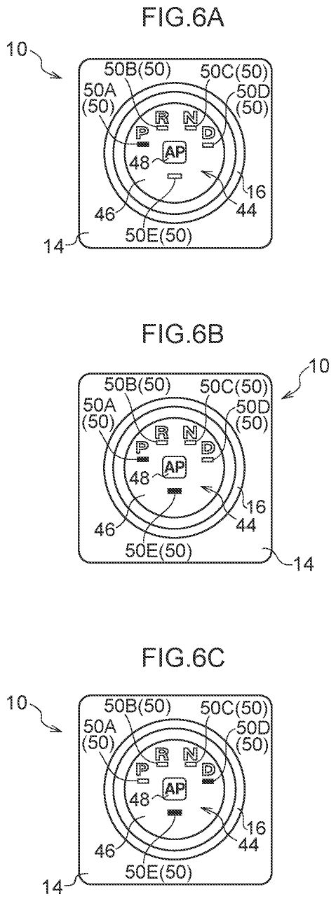

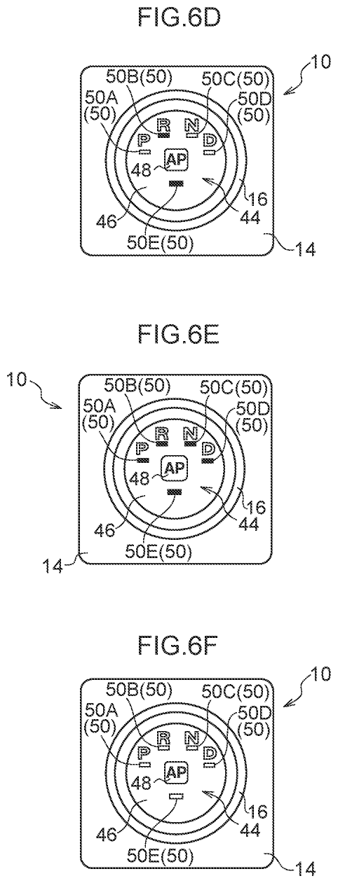

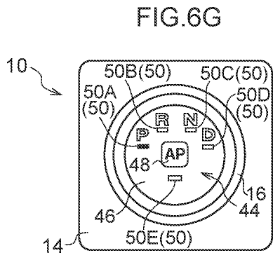

Next, explanation follows regarding display on the indicator 44 when the control device 56 is in the automated parking mode, with reference to FIG. 4 to FIGS. 6. FIG. 4 illustrates a flow of illumination control (illumination processing) of the indicator 44 executed by the controller 52. FIG. 5A to FIG. 5F are plan views illustrating positions of a vehicle (own-vehicle) 66 in the automated parking mode. FIG. 6A to FIG. 6G are plan views illustrating illumination states of the lamps 50 (50A to 50E) of the indicator 44. As illustrated in FIG. 5A to FIG. 5F, the present exemplary embodiment explains an example in which side-by-side parking is performed to park the vehicle (own-vehicle) 66 in a parking space 70 between a vehicle 68A and a vehicle 68B.

As illustrated in FIG. 5A, when the automated parking mode is to be executed, an occupant (the driver) stops the vehicle 66 at a position where the parking space 70 can be ascertained and rotates the knob 16 of the shift device 10 to the P position such that the shift range of the automatic transmission 60 is set to the P range. Thus, as illustrated in FIG. 6A, the lamp 50A is illuminated on the indicator 44 so as to display that the shift range of the automatic transmission 60 is the P range. When the AP switch 48 of the shift device 10 is operated in this state, operation of the control device 56 in the automated parking mode is initiated. Note that although the vehicle 66 has stopped in front of the vehicle 68A in FIG. 5A, the vehicle 66 may be stopped in front of the vehicle 68B. In cases in which the AP switch 48 is operated in a state in which the knob 16 is at a shift position other than the P position, operation of the AP switch 48 is invalid and operation of the automated parking mode is not initiated.

The flowchart illustrated in FIG. 4 is executed on initiation of operation of the control device 56 in the automated parking mode. At the first step 100, the lamp 50A indicating the P range and the lamp 50E are both illuminated. Thus, as illustrated in FIG. 6B, the lamp 50A indicating the P range and the lamp 50E indicating the automated parking mode are both illuminated on the indicator 44 so as to display that operation of the automated parking mode has been initiated.

When operation of the automated parking mode has been initiated, the control device 56 changes the shift range of the automatic transmission 60 to the D range, moves the front of the vehicle 66 forward to a side of the parking space 70 (see FIG. 5B), and uses the monitoring device to perceive the parking space 70 (to check the position, width, and so on of the parking space 70). The vehicle 66 is then moved forward to in front of the vehicle 68B and the steering is manipulated to point the rear of the vehicle 66 toward the parking space 70 within the available range (see FIG. 5C).

The shift range of the automatic transmission 60 is then changed to the R range, and the steering is manipulated as the vehicle 66 is reversed into the parking space 70 (see FIG. 5D). When the vehicle 66 has reversed to a predetermined position (reverse limit position), the shift range of the automatic transmission 60 is changed to the D range and the steering is manipulated as the vehicle 66 is moved forward (see FIG. 5E). The control device 56 alternates between reversing and moving the vehicle 66 forward in this manner while manipulating the steering.

As illustrated in FIG. 4, at step 102 the controller 52 checks whether or not the shift range of the automatic transmission 60 has changed, and at step 104 the controller 52 checks whether or not the automated parking mode has ended.

Note that when the shift range of the automatic transmission 60 has been changed from the P range to the D range in order to move the vehicle 66 forward, an affirmative determination is made at step 102, and processing transitions to step 106. At step 106, the lamp 50 (50D) corresponding to the changed shift range is illuminated (see FIG. 6C). When this is performed, the controller 52 sequentially illuminates the lamps, 50A, 50B, 50C, and 50D in turn as the shift range changes from the P range to the D range by passing through the R range and the N range. When the vehicle 66 is switched back and forth between forward and reverse in the automated parking mode, the shift range is changed from the D range to the R range through the N range and the lamp 50D, the lamp 50C, and the lamp 50B on the indicator 44 are sequentially illuminated in turn, after which the shift range is changed from the R range to the D range through the N range and the lamp 50B, the lamp 50C, and the lamp 50D on the indicator 44 are sequentially illuminated in turn (see FIG. 6D and FIG. 6C).

When it becomes possible to reverse the vehicle 66 until it is parked in (guided into) the parking space 70, the control device 56 changes the shift range of the automatic transmission 60 to the R range and manipulates the steering while reversing the vehicle 66. After the vehicle 66 has been moved into the parking space 70, the control device 56 stops (stations) the vehicle 66 at a predetermined position (such as a position where the rear wheels of the vehicle 66 contact a parking block) (see FIG. 5E and FIG. 5F). When this is performed, the controller 52 changes the shift range from the D range to the R range through the N range, and so sequentially illuminates the lamp 50D, the lamp 50C, and the lamp 50B on the indicator 44 in turn (see FIG. 6E). The control device 56 then changes the shift range of the automatic transmission 60 to the P range and ends operation of the automated parking mode. The engine 58 may be stopped when the automated parking mode is ended.

In the flowchart in FIG. 4, an affirmative determination is made at step 104 when the automated parking mode has ended. Processing then transitions to step 108. At step 108, each of the lamps 50A to 50E are illuminated (or made to flash) in a set pattern (illumination format) so as to display the fact that operation of the automated parking mode has ended. Then, at step 110, the lamp 50E that indicated that the automated parking mode was in operation is switched off. At step 112, the lamp 50 (lamp 50A) corresponding to each shift range of the automatic transmission 60 is illuminated, display corresponding to the automated parking mode is ended, and processing transitions to display processing corresponding to the normal mode.

When the automated parking mode has ended, the controller 52 repeatedly illuminates all the lamps 50A to 50E (see FIG. 6E) and switches off all the lamps 50A to 50E (see FIG. 6F) a predetermined number of times. The controller 52 then illuminates the lamp 50A corresponding to the P range, this being the shift range after the end of the automated parking mode, without illuminating the lamp 50E (see FIG. 6G).

The indicator 44 is provided to the shift device 10, and the indicator 44 displays the shift range of the automatic transmission 60. Thus, when the shift range of the automatic transmission 60 changes from the P range (to the D range and the R range) due to the operation of the control device 56 in the automated parking mode in a state in which the knob 16 is disposed at the P position, the occupant is able to perceive the shift range of the automatic transmission 60 by looking at the indicator 44 of the shift device 10. Thus, even if the shift position of the knob 16 does not correspond to the shift range of the automatic transmission 60 when the occupant looks at the shift device 10, the occupant is still able to perceive the shift range of the automatic transmission 60, thereby enabling any confusion felt on the part of the occupant to be suppressed.

Furthermore, the knob 16 is formed with a circular outer profile, and the knob 16 is rotated about its central axis to change the shift position of the knob 16. When this is performed, the shift position changes each time the knob 16 is rotated by a predetermined rotation angle. Moreover, the portion of the knob 16 exposed to the vehicle cabin interior is configured similarly around the entirety of the circumferential rotation direction, and the external profile (the appearance) of the knob 16 is the same at each shift position. Thus, the external profile (appearance) of the knob 16 is the same both in a state in which the knob 16 is disposed at the P position and in states in which the knob 16 is disposed at shift positions other than the P position. Thus, the external profile of the knob 16 is not displaced when the shift position of the knob 16 changes, and so the occupant does not have to look at the external profile of the knob 16 in order to perceive the shift position of the knob 16. Thus, even if the shift position of the knob 16 does not correspond to the shift range of the automatic transmission 60 when the occupant looks at the shift device 10, since the occupant does not have to look at the external profile of the knob 16 in order to perceive the shift position of the knob 16 due to being able to perceive the shift range of the automatic transmission 60 using the indicator 44, any confusion felt on the part of the occupant can be further suppressed.

Moreover, the AP switch 48 is provided on the indicator 44 of the shift device 10. Operation of the control device 56 in the automated parking mode is initiated when the occupant operates the AP switch 48. The occupant is thus able to initiate operation of the control device 56 in the automated parking mode by looking at the indicator 44 of the shift device 10 and operating the AP switch 48, and the occupant is able to perceive the operation status of the control device 56 in the automated parking mode by looking at the indicator 44 of the shift device 10.

Furthermore, the lamp 50E is provided on the indicator 44 of the shift device 10, and the lamp 50E is illuminated to display that the control device 56 is operating in the automated parking mode. Thus, the occupant is able to perceive that the control device 56 is operating in the automated parking mode by looking at the lamp 50E on the shift device 10.

Moreover, when the control device 56 initiates and ends operation of the automated parking mode, the shift range of the automatic transmission 60 is set to the P range, such that the vehicle is set to a stop state. This enables an improvement in vehicle safety when the control device 56 operates in the automated parking mode.

Furthermore, the shift lock mechanism 24 is operated such that rotation of the knob 16 from the P position is locked while the control device 56 is operating in the automated parking mode. Thus, the shift position of the knob 16 is restricted from changing while the control device 56 is operating in the automated parking mode, enabling the occupant to be restricted from changing the shift range of the automatic transmission 60, and thereby enabling an improvement in travel safety of the vehicle 66.

Moreover, the lamps 50A to 50E are provided to the indicator 44 of the shift device 10. When the control device 56 ends operation of the automated parking mode, all the lamps 50A to 50E are illuminated (see FIG. 6E) and then all the lamps 50A to 50E are switched off (see FIG. 6F) for a predetermined number of repetitions, thereby displaying that the control device 56 has ended operation of the automated parking mode. Thus, the occupant is able to perceive that the control device 56 has ended operation of the automated parking mode by looking at the lamps 50A to 50E on the shift device 10.

Furthermore, the indicator 44 is installed at a portion of the shift device 10 other than the knob 16 (such as the indicator panel 46). This enables easy installation of the indicator 44 to the shift device 10. Furthermore, the indicator 44 is installed at an inner side, in the radial direction, of the knob 16, and the lamps 50A to 50E and the AP switch 48 of the indicator 44 are installed close to each other. This enables the occupant to easily perceive the lamps 50A to 50E and the AP switch 48 when looking at the shift device 10.

Note that although the indicator 44, serving as a display section, is provided at the radial direction inside of the knob 16 in the present exemplary embodiment as described above, the position of the display section is not limited thereto. As long as the occupant is able to look at the display section (indicator 44), the display section may be provided at a portion of the shift device 10 other than at the radial direction inside of the knob 16 (such as on the knob 16 or the casing).

In cases in which the indicator 44 is provided on the knob 16, the display section may be incorporated into the shift body, thereby facilitating manufacture of the shift device.

The lamps 50 provided to the indicator 44 may be configured such that the illumination color of the lamps 50A to 50D that are illuminated corresponding to each shift range of the automatic transmission 60 is different from the illumination color of the lamp 50E that is illuminated when the control device 56 is operating in the automated parking mode. This enables the fact that the control device 56 is operating in the automated parking mode to be more clearly displayed.

Furthermore, in the present exemplary embodiment, all the lamps 50A to 50E are illuminated and switched off repeatedly when the control device 56 has ended operation of the automated parking mode. However, as long as the illumination state is able to display that the control device 56 has ended operation of the automated parking mode, there is no limitation thereto. For example, when flashing the lamps 50A to 50E repeatedly, the lamps 50 may be illuminated in a different color each time or the lamps 50 may be illuminated with different colors to each other, or the lamps 50A to 50E may be illuminated in sequence plural times.

Moreover, in the present exemplary embodiment, the specific shift range of the automatic transmission 60 is the P range, and the specific shift position of the knob 16 is the P position. However, the specific shift range of the automatic transmission 60 is not limited to the P range, and may be another shift range (such as the N range that sets the vehicle to a stop state), and the specific shift position of the knob 16 may be another shift position. Configuration may be such that in cases in which the specific shift position of the knob 16 is the N position, when the knob 16 is disposed at the N position (when the shift sensor 54 has detected that the shift position of the knob 16 is the N position), or when a non-illustrated lock switch has been operated, the restricting projection 40C of the second lever 40 is inserted into the lever engagement recess 16B, thereby locking rotation of the knob 16 from the N position.

Moreover, although the momentary type AP switch 48, serving as an initiating section, is provided to the indicator panel 46 in the present exemplary embodiment, the initiating section and the position thereof are not limited thereto. It is sufficient that the initiating section be configured including a return function to return to a state prior to initiating the driving assistance mode after the driving assistance mode has ended. As long as the initiating section is at a position where the initiating section can be seen by the occupant, the initiating section may be provided at a portion of the shift device 10 other than the indicator panel 46 (such as the knob 16 or the casing).

Furthermore, in the present exemplary embodiment, an example has been given of the automated parking mode serving as a driving assistance mode in which side-by-side parking is performed. However, the automated parking mode may perform end-to-end parking, or parking in a garage. Moreover, the driving assistance mode (automated driving mode) is not limited to an automated parking mode. The driving assistance mode may be a self-driving mode in which the vehicle drives itself (travels) automatically, or the driving assistance mode may be applied to a configuration in which a driving assistance device changes the shift range of the transmission instead of the occupant.

Moreover, in the present exemplary embodiment, the knob 16, serving as a shift body, is rotated about its axis. However, a lever that rocks or slides may serve as a shift body.

Furthermore, in the present exemplary embodiment, the shift device 10 is installed at the console. However, the shift device 10 may be installed at an instrument panel, a column cover, or to the floor of the vehicle cabin.

The entire content of the disclosure of Japanese Patent Application No. 2017-125214 filed on Jun. 27, 2017 is incorporated by reference in the present specification.

All cited documents, patent applications, and technical standards mentioned in the present specification are incorporated by reference in the present specification to the same extent as if each individual cited document, patent application, or technical standard was specifically and individually indicated to be incorporated by reference.

1. A shift device, comprising:
a shift body configured to be movable to a plurality of shift positions in order to change a shift range of a transmission to a shift range corresponding to each shift position; and
a display section configured to display a shift range of the transmission when the shift range is changed by operation of a vehicle driving assistance mode, in a state in which the shift body is disposed at a specific shift position.

2. The shift device of claim 1, wherein the display section is further configured to display that the driving assistance mode is in operation.

3. The shift device of claim 1, further comprising an initiating section that is operated to initiate operation of the driving assistance mode.

4. The shift device of claim 1, wherein the shift range of the transmission is set to a vehicle stop state corresponding to the specific shift position when operation of the driving assistance mode is initiated and when operation of the driving assistance mode ends.

5. The shift device of claim 1, further comprising a restricting section configured to restrict movement of the shift body from the specific shift position during operation of the driving assistance mode.

6. The shift device of claim 1, wherein the display section is configured to display that operation of the driving assistance mode has ended.

7. The shift device of claim 1, wherein:
the shift body is rotated through a predetermined rotation angle to change the shift position of the shift body; and
an external profile of the shift body is the same at each shift position of the shift body about an entirety of a circumferential rotation direction of the shift body.

8. The shift device of claim 1, wherein the display section is installed at the shift body.

9. The shift device of claim 1, wherein the display section is installed at a portion of the shift device other than the shift body.

10. The shift device of claim 1, wherein:
the shift body has an annular shape rotatable about an axis of the shift body; and the display section is installed at an inner side, in a radial direction, of the shift body.
